(19) United States
(12) Patent Application Publication
(10) Pub. No.: US 2014/0238171 A1
(43) Pub. Date: Aug. 28, 2014

(54) GEAR WITH RIGIDLY CONNECTED DRIVESHAFT

(71) Applicant: Michael Kastrup, Bad Krozingen (DE)

(72) Inventor: Michael Kastrup, Bad Krozingen (DE)

(21) Appl. No.: 14/343,872

(22) PCT Filed: Aug. 31, 2012
(86) PCT No.: PCT/EP2012/003664

§ 371 Date: Mar. 10, 2014

(30) Foreign Application Priority Data
Nov. 2, 2011 (DE) 102011119514.2

(51) Int. Cl. F16H 55/06

(52) U.S. Cl. CPC F16H 55/06; F16H 2055/065
USPC 74/434

(57) ABSTRACT

The invention relates to a gear which is rotationally fixed on a driveshaft. The gear consists of injection-molded plastic, and the driveshaft consists of a plastic material which is different from the gear, said shaft being encapsulated by the gear. The shaft consists of plastic, and the plastic of the gear has a higher elasticity than the plastic of the shaft. The shaft has a connecting region which increases the diameter of the shaft in the connecting region where the shaft is encapsulated by the gear.

The invention relates to a gear that is rotationally fixed to a drive shaft and that is made of injection-molded plastic, the drive shaft being made of a plastic material that is different from that of the gear.

Gears made of plastic are well known in a variety of applications in which power must be transmitted or the direction of force must be changed. Plastic gears are used here in applications in which lower torque is being transmitted. This is true since plastic gears can transmit lower torque than metal gears. The use of gear trains that contain plastic gears is also provided in lightweight gear trains in order to save weight. In addition to portable tools, applications here include kitchen appliances and toys.

Plastic gears are also utilized in gear trains so as to reduce noise. Certain mesh-rolling noises are generated when metal gear teeth engage and the metal teeth roll against each other. Using plastic gears enables this generation of noise to be reduced.

The gear trains, or also drive shafts, on which the gears are located are made of metal. Metal is preferably used here as the shaft material because drive shafts are subject to a bending load during every revolution when torque is transmitted and torque is converted by gears, and because metal shafts have good long-term flexural strength.

In addition, drive shafts made of hardened or alloyed steel are used since they have increased fatigue strength, improved corrosion resistance, and increased wear resistance at the bearing positions. The use of alloyed and hardened steels for shafts here also enables the shafts to have a high surface quality once they have been appropriately machined. The use of tempered and hardened steels is also advantageous in gear trains that are only required to transmit low-level torque. The shaft here at the support positions and bearing positions has a sufficiently high surface quality that the shaft forms a slide bearing with the contact positions of the gear train housing and air as the lubricating agent. This eliminates the need to employ rolling-contact bearings for supporting the gear train.

A variety of methods exist to attach the shaft and gear to each other. The most widely used approaches are the these two: Plastic gears are either pressed onto the shafts such that an interference fit determines the possible torque transmission between shaft and gear, or positive-locking attachment is provided by constructive design between shaft and gear, such as for example through a shaft-hub attachment in the form of splined shaft.

However, this attachment between plastic gear and metal drive shaft has various disadvantages. When under load, the respective molecular lattices respond differently due to the fact that a metal shaft and a plastic gear have different material properties. The result is that peak loads can loosen or damage the attachment point between shaft and gear. The level of transmittable torque is thus continuously reduced.

A further disadvantage is that producing a treated hardened drive shaft is a complex and cost-intensive multistep process. High material costs are also incurred since the treatment of the steel is expensive.

Material optimization of plastic materials and new production methods also allow increasingly stronger gears to be manufactured. The use of metal shafts in plastic gear trains also has revealed that failure of the gear train can often be attributed to fracture, for example brittle fracture of the shaft. In particular, this happens whenever the drive train is blocked and a peak load occurs as the shaft of the gear train starts running.

The object of the invention is to eliminate the above-described disadvantages of the prior art. The primary goal here is to provide a gear with a integral shaft that does not include an attachment position that can undergo fatigue or be destroyed when under a constant load.

This object is achieved by the above-described gear with integral drive shaft, where first the shaft is overmolded by the gear, second the shaft is made of plastic and the plastic of the gear has a higher elasticity than the plastic of the shaft, and third the shaft has an attachment region enlarging the shaft diameter in the attachment region in which the shaft is overmolded by the gear.

The use of plastic for the drive shaft is advantageous in that the shaft material is more elastic than metal, while the risk of brittle fraction is lower under peak loads. The long-term stability is also considerably enhanced by the improved bending elasticity.

Another advantage is that no corrosion problems occur in a drive shaft made of plastic since only noncorroding materials are used in the gear train.

An advantage is the fact that the use of plastic shafts further reduces weight in comparison with metal shafts.

An advantage is the fact that plastic conducts sound waves and thus noise much less effectively than metal. The use of a plastic shaft enables the conduction of structure-borne sound within the gear train to be further reduced, and the emitted noise level is also reduced.

An advantageous approach is coating the drive shaft with special finish coatings, such as for example a hard finish coating that is hardened by W. The frictional and sliding properties of the shaft surface can thus be improved at the requisite positions along the drive shaft in order to provide thereby, for example a slide bearing functionality between drive shaft and a housing. The attachment region of the drive shaft advantageously has the shape of a disk since this enables the gear to be overmolded uniformly. This can also be achieved by an approach wherein the attachment region of the shaft has the shape of a coaxial annular disk.

It is especially advantageous if the disk includes projections, recesses, holes, and/or flat areas around the outer edge and/or on at least one side face since this provides effective positive engagement between the drive shaft and the gear after the gear has been overmolded. Another advantageous embodiment entails having teeth project from the outer edge of the disk, or for the disk to be formed as a spur gear.

It is advantageous that the ratio of shaft diameter to disk diameter or gear diameter ranges between 1:3 and 1:5. This provides an effective ratio between the possible applied torque and the quantity of material.

Using a hollow shaft for the drive shaft enables material to be saved, along with providing enhanced bending stability and performance stability.

An embodiment of the invention is shown in the drawing and is described in detail below.

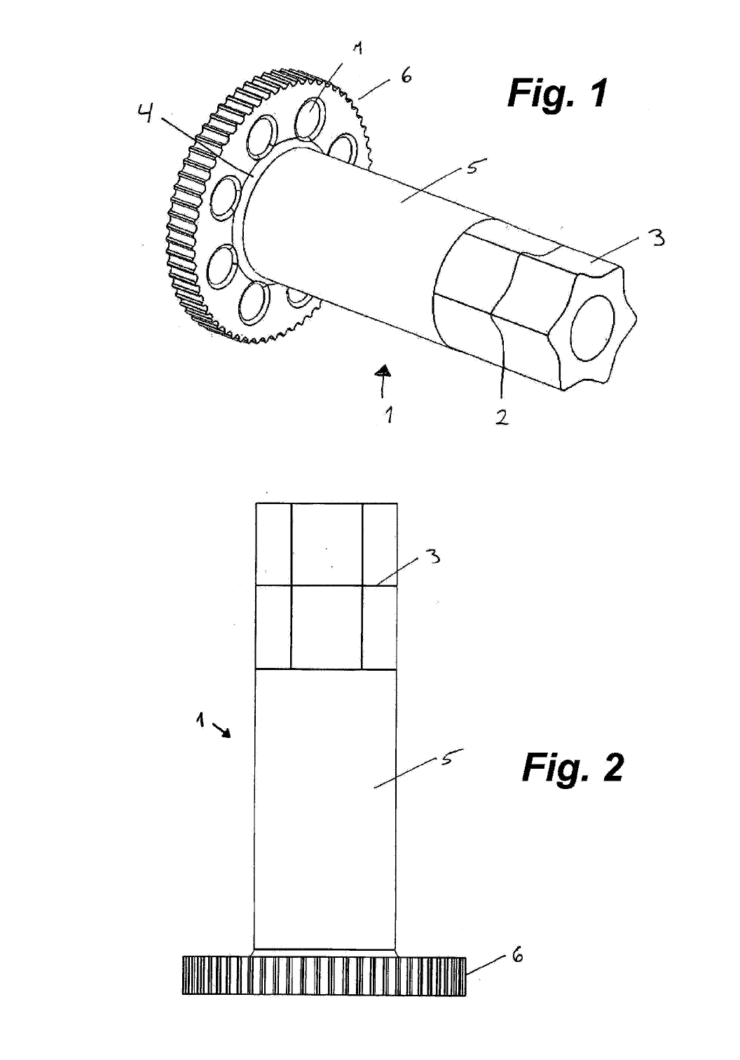

FIG. 1 is a perspective view of the drive shaft;

FIG. 2 is a top view of the drive shaft;

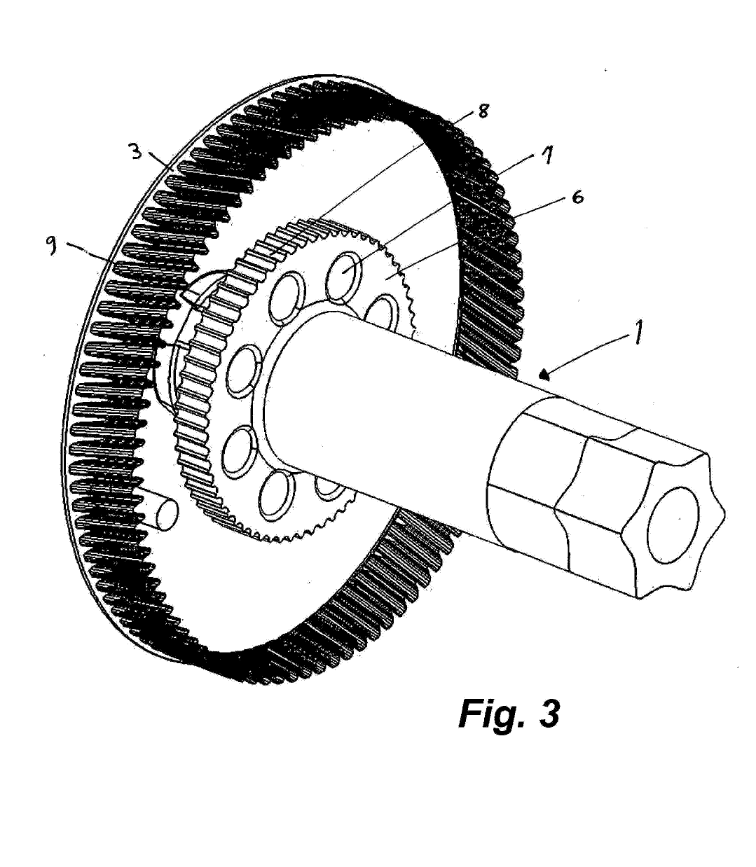

FIG. 3 is a perspective view of attached gear and drive shaft;

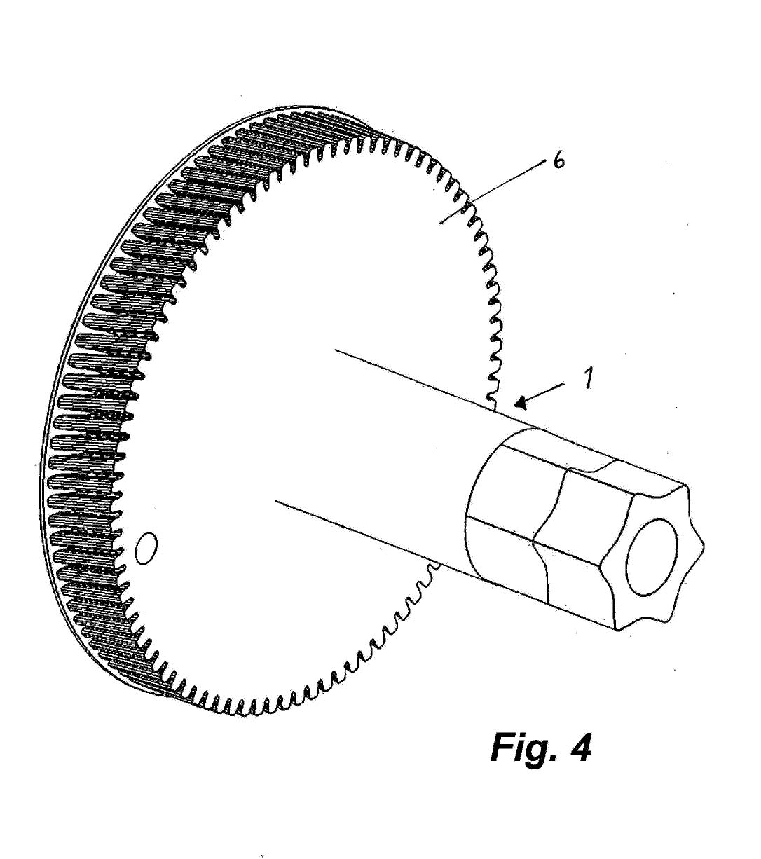

FIG. 4 is a diagram depicting gear with attached drive shaft;

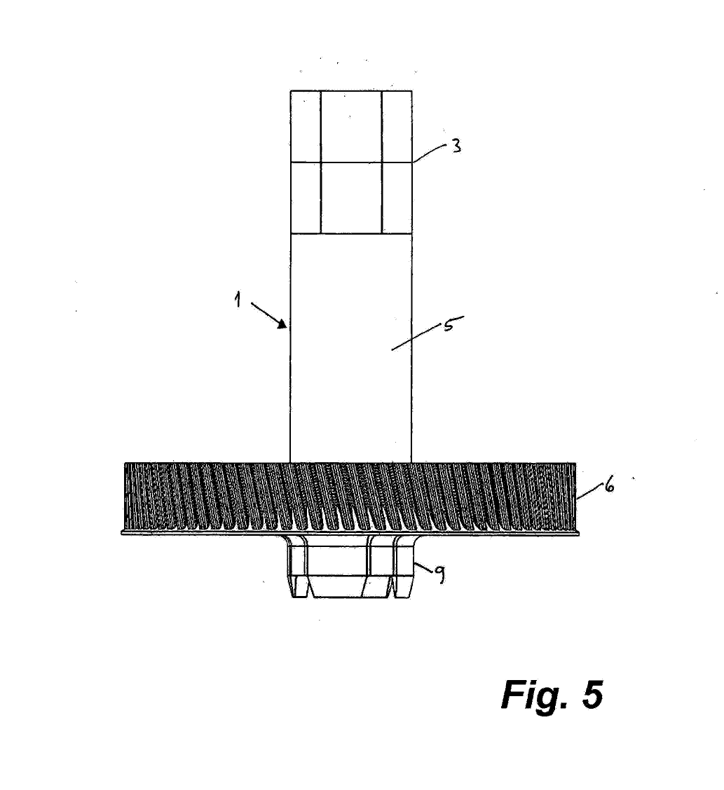

FIG. 5 is a top view of gear and drive shaft

FIG. 1 is a perspective view showing a variant of the drive shaft 1. At the shaft end 2 that faces the viewer, the drive shaft 1 has a torx shape forming a coupling 3 for attaching additional components of the drive train. A shaft section 5 of the plastic shaft having a smooth surface extends from this shaft end toward the shaft end 4 opposite the viewer. A large-diameter shaft portion 6 adjoins the shaft section 5. In the variant shown, this is in the form of a spur gear that is formed with holes 7. The illustrated drive shaft 1 is tubular.

FIG. 2 is a top view of the drive shaft 1. The top view reveals the three-part division of the drive shaft 1 at the shaft end in torx shape as the coupling 3, the shaft section 5 of the plastic shaft having a smooth surface, and the large-diameter portion 6. In this variant, the finish coating provided to optimize the surface quality, etc., is applied in the shaft section 5 of the plastic shaft having a smooth surface.

The perspective view of FIG. 3 illustrates that the gear 3, which is a spur gear, surrounds the drive shaft 1. The gear here simultaneously also surrounds the large-diameter portion 6 formed as a spur gear with holes 7. The partially transparent view of the gear reveals that during injection molding the material of the gear 3 fills both the spaces between its teeth 8 and also the holes 7 of the large-diameter portion 6 so as to produce an effective, positive, and permanent attachment.

FIG. 4 is a perspective view illustrating the gear 3 with the integral drive shaft 1, as in previous FIG. 3. However the gear is shown as partially transparent here. This illustration shows an extension of the shaft by a shaft shoulder 9 that is created in this embodiment of the gear during the injection molding of the gear. The shaft shoulder 9 is not created, for example if the gear does not surround the shaft at one of shaft ends 2 or 4 but instead surrounds it at the center of the shaft.

FIG. 5 is a top view of the gear 3 with integral drive shaft 1. Depending on the surface properties of the type of embodiment, the shaft shoulder 9 can be provided with a finish coating in the region 5 so as to provide an effective bearing position.

Additional embodiments, which are not shown in the figures, are as follows:

In another embodiment, the attachment region of the shaft has the shape of a disk or a coaxial annular disk.

In another embodiment, the attachment region is a disk that includes projections, recesses, holes, and/or flat areas around the outer surface and/or on at least one face surface. In a further embodiment, teeth are disposed around the outer surface of the disk. This can be effected in an embodiment wherein the disk is a spur gear.

In other embodiments, the ratio of shaft diameter to disk diameter or gear diameter ranges between 1:3 and 1:5. The shaft diameter becomes larger for greater amounts of torque to be transmitted, and becomes smaller for smaller amounts of torque to be transmitted. This enables the amount of material used to be limited so as to match the designated purpose in terms of the constructive design, thereby saving weight and material cost.

In another embodiment, not shown, the shaft is a solid shaft.

In one particular embodiment, the gear is a spur gear.

One embodiment comprises an approach whereby the shaft is coated with a plastic finish coating.

In another variant embodiment, the shaft is coated with a plastic finish coating only in the region of the bearing positions.

Another variant embodiment comprises an approach whereby the coating is effected with a finish coating that is hardened by drying, and has a hard and smooth surface.

One variant embodiment comprises an approach whereby the gear with its shaft is produced using a multi-component injection-molding method or insertion method.

Depending on the designated purpose, the plastic material of the gear in the possible variant embodiments is preferably made of polyoxymethylene, polyamide, polybutylene terephthalate, polyphenylene sulfide, polyether ether ketone, or polypropylene.

Depending on the designated purpose, the plastic material of the shaft is preferably made of polyoxymethylene, polyamide, polybutylene terephthalate, polyphenylene sulfide, polyether ether ketone, or polypropylene.

1. A gear rotationally fixed to a drive shaft, wherein the gear is made of injection-molded plastic, and the drive shaft is made of a plastic material that is different from the gear, wherein
the shaft is overmolded by the gear,
the shaft is made of plastic and the plastic of the gear has a higher elasticity than the plastic of the shaft, and
the shaft where the shaft is overmolded by the gear has an attachment region enlarging the shaft diameter.

2. The gear with drive shaft according to claim 1, wherein the attachment region of the shaft is a disk.

3. The gear with drive shaft according to claim 1, wherein the attachment region of the shaft has the shape of a coaxial annular disk.

4. The gear with drive shaft according to claim 2, wherein the disk includes projections, recesses, holes, or flat areas around the outer edge or on at least one side face.

5. The gear with drive shaft according to claim 4, wherein teeth are provided around the outer edge of the disk.

6. The gear with drive shaft according to claim 1, wherein the ratio of shaft diameter to disk diameter or gear diameter ranges between 1:3 and 1:5.

7. The gear with drive shaft according to claim 1, wherein the shaft is tubular.

8. The gear with drive shaft according to claim 1, wherein the gear is a spur gear.

9. The gear with drive shaft according to claim 1, wherein the plastic of the gear completely surrounds the large-diameter portion of the shaft.

10. The gear with drive shaft according to claim 1, wherein the shaft is coated with a plastic finish coating.

11. The gear with drive shaft according to claim 1, wherein the shaft is coated with a plastic finish coating only at bearing positions.

12. The gear with drive shaft according to claim 1, wherein the large-diameter portion is overmolded with the plastic of the gear when the shaft is produced.

13. The gear with drive shaft according to claim 11, wherein the coating with a finish coating is effected which is hardened by drying and has a hard and smooth surface.

14. The gear with drive shaft according to claim 1, wherein the gear together with its shaft is produced using a multicomponent injection-molding method or insertion method.

15. The gear with drive shaft according to claim 1, wherein the plastic material of the gear is preferably polyoxymethylene, polyamide, polybutylene terephthalate, polyphenylene sulfide, polyether ether ketone, or polypropylene.

16. The gear with drive shaft according to claim 1, wherein the plastic material of the shaft is preferably polyoxymethylene, polyamide, polybutylene terephthalate, polyphenylene sulfide, polyether ether ketone, or polypropylene.
